(19) United States
(12) Patent Application Publication
(10) Pub. No.: US 2009/0081384 A1
(43) Pub. Date: Mar. 26, 2009

(54) Low Wetting Hysteresis Polysiloxane-Based Material and Method for Depositing Same

(75) Inventors: Marc Plissonnier, Eybens (FR); Mathias Borella, Grenoble (FR); Frederic Gaillard, Voiron (FR); Pascal Faucherand, Sassenage (FR)

Correspondence Address: OLIFF & BERRIDGE, PLC, P.O. BOX 320850, ALEXANDRIA, VA, 22320-4850, US

(73) Assignee: COMMISSARIAT A L'ENERGIE ATOMIQUE, Paris (FR)

(21) Appl. No.: 11/922,421

(22) PCT Filed: Jun. 27, 2006
(86) PCT No.: PCT/FR2006/001492

§ 371 Date: Dec. 18, 2007

(30) Foreign Application Priority Data
Jul. 1, 2005 (FR) 0507024

(51) Int. Cl. B05D 5/00; C08G 77/04

(52) U.S. Cl. 427/578; 528/37

(57) ABSTRACT

A polysiloxane-based material presents a predetermined structure or conformation such that the polysiloxane-based material comprises a ratio between a number of linear —Si—O— bonds and a number of cyclic —Si—O— bonds less than or equal to 0.4, and preferably less than or equal to 0.3. Such a polysiloxane-based material enables a wetting hysteresis less than 10°, and preferably less than 5° to be obtained. Such a low wetting hysteresis material can be achieved by chemical vapor deposition enhanced by a plasma wherein a precursor is injected. The precursor is selected from the group consisting of cyclic organosiloxanes such as octamethylcyclotetrasiloxane and derivatives thereof and cyclic organosilazanes such as octamethylcyclosilazane and derivatives thereof. A ratio between a power density dissipated in the plasma and a precursor flow rate injected in the plasma is less than or equal to 100 W.cm⁻²/mol.min⁻¹.

### BACKGROUND OF THE INVENTION

The invention relates to a material with a low wetting hysteresis, used in particular as surface coating, and to a deposition method of such a material on a surface.

### STATE OF THE ART

As illustrated in FIG. 1, when a drop of liquid 1 is placed on a flat solid surface 2, it either remains in the form of a drop or it spreads by wettability on the surface 2. The behaviour of the drop 1 is directly linked to the surface energy of the material forming the surface 2 and it can be predicted by measuring the contact angle θ. This angle corresponds to the angle between the tangent to the drop 1 at the point of contact P and the solid surface 2.

The shape of the drop of liquid 1 is in fact governed by three forces γ₁, γ₂ and γ₃, able to be described as interface tensions or surface tensions, respectively between the surface 2 and the environment external to the drop 1 (for example air), between the liquid 1 and the external environment and between the surface 2 and liquid 1. At a given time, these three forces are linked by the following equation: γ₁−(γ₂ cos θ+γ₃)=S. When S is positive, the drop of liquid 1 spreads on surface 2, and when S is negative, the liquid remains in the form of a drop.

Measuring the contact angle θ also enables it to be determined whether a solid surface is hydrophobic or hydrophilic. A material is in fact considered to be hydrophobic when the contact angle θ is greater than 90°. For example it is possible to move and/or handle drops of liquid by means of the Electrowetting-on-dielectric (EWOD) principle. This principle consists in depositing a drop on a substrate comprising a first electrode array and coated with a hydrophobic insulating coating. A second electrode array is arranged facing the first array, above the drop, so as to apply a voltage locally between two electrodes of the first and second arrays. The surface of the coating zone where the voltage is applied moreover forms a capacitance with the electrode of the second array, it charges and attracts the drop creating a force causing movement or spreading of the drop. It is then possible to move liquids, step by step, and to mix them.

The electrowetting principle requires the free surface on which the drop is placed to be very hydrophobic. Therefore, to obtain a significant movement, it is generally necessary to obtain an contact angle θ greater than or equal to 100°. Movement, handling or deformation of a drop also has to be appreciably reversible, i.e. when the force causing movement or deformation of the drop is no longer applied, the system composed of the hydrophobic surface and the drop arranged on said surface must be in a state that is as close as possible to the initial state. This reversibility essentially depends on a phenomenon called wetting hysteresis, itself dependent on the density, the uniformity of thickness, the roughness and the chemical homogeneity of the surface.

The wetting hysteresis, also referred to as wetting-dewetting hysteresis or contact angle hysteresis (CAH) of a surface, in fact determines the state of the system after a spreading or movement force has been applied, which enables it to be determined whether a second spreading or movement can be performed. The wetting hysteresis of a surface in fact corresponds to a refusal to wet a dry surface, when the drop slides on said surface. This phenomenon then manifests itself by an increase of the contact angle on the side where the drop advances, also called advancing angle θₐ. Likewise, a previously wetted surface tends to retain the drop, which generates a smaller contact angle on the side where the drop recedes, also called receding angle θ. For illustration purposes, the advancing angle θₐ and the receding angle θᵣ are represented in FIG. 2, where a drop of liquid 1 is disposed on an inclined hydrophobic surface 2. The wetting hysteresis of surface 2 is thereby determined by measuring the difference between the maximum advancing angle θ_{a max} and the minimum receding angle θ_{r min}. As illustrated in FIGS. 3 and 4, this measurement is for example obtained by using a syringe 3 to deposit a drop 1 of liquid, for example ultra-pure water, on a surface 2. Then, keeping the syringe 3 in the drop 1 and by means of a motorized system able to move the syringe 3 downwards (arrow F1) or upwards (arrow F2) so as to increase or decrease the volume of the drop, the advancing angle θₐ (FIG. 3) and the receding angle θᵣ (FIG. 4) can respectively be measured. Measurement of the contact angle is more particularly performed by means of a camera (not shown) and image processing means.

The greater the difference between the maximum advancing angle θ_{a max} and the minimum receding angle θ_{r min}, the greater the wetting hysteresis of the surface coating and the more difficulty the drop of water has in moving. On the contrary, when the wetting hysteresis is zero, the surface can be considered to be perfectly slippery. Generally speaking, in a large number of fields such as electrowetting-on-dielectric, it is desirable to obtain a hydrophobic surface coating having a wetting hysteresis less than or equal to 15°, and preferably less than or equal to 10°. However, few materials enable a surface coating presenting a very low wetting hysteresis to be obtained.

The presence of a hysteresis when wetting/dewetting takes place is generally due to chemical surface heterogeneities or to surface roughnesses which are either natural or obtained when the different microfabrication steps are performed. Thus, certain people, such as David Quéré et al., in the article “Slippy and sticky microtextured solids” (Institute of Physics Publishing, Nanotechnology 14 (2003) 1109-1112) have attempted to control the contact angle and the wetting hysteresis of a hydrophobic surface by microtexturing said surface. This technique is however not satisfactory in so far as it requires an additional surface treatment step. For example, the surface treatment step can be etching by photolithography in the course of which ion bombardment is liable to modify the surface properties of the material, or it may involve a mechanical machining step, which then requires the use of a hydrophobic initial material over a large part of its thickness.

The article “Improving the Adhesion of Siloxane-Based Plasma Coatings on Polymers with Defined Wetting Properties” by D. Hegemann et al. (45th Annual Technical Conference Proceedings (2002), pages 174-178) studies the conditions of plasma enhanced chemical vapor deposition of siloxane-based hydrophobic films, so as to obtain defined surface properties. The precursor used to perform PECVD is the linear hexamethyldisiloxane (HMDSO) precursor. The contact angle can vary between 15° and 110°, depending on the carbon content of the siloxane-based film deposited from the HMDSO precursor. A film close to polydimethylsiloxane (PDMS) was thus deposited on a polycarbonate (PC) or PC/acrylonitrile-butadiene-styrene resin (ABS) support by PECVD with pure HDMSO as precursor, low reaction parameter values and pre-treatment with nitrogen. A hydrophobic siloxane-based film can thus, with optimized deposition conditions, present an advancing angle θₐ of 110° and a receding angle θᵣ of 97°, the wetting hysteresis then being 13°.

### OBJECT OF THE INVENTION

The object of the invention is to provide a preferably hydrophobic material presenting a low wetting hysteresis, while at the same time remedying the shortcomings of the prior art.

According to the invention, this object is achieved by the appended claims.

More particularly, this object is achieved by the fact that the material is a polysiloxane-based material for which the ratio between the number of linear —Si—O— bonds and the number of cyclic —Si—O— bonds is less than or equal to 0.4.

According to a development of the invention, the ratio between the number of linear —Si—O— bonds and the number of cyclic —Si—O— bonds is less than or equal to 0.3.

It is a further object of the invention to provide a method for depositing such a low wetting hysteresis material on a surface, a method which is easy to implement and does not require a subsequent surface treatment step.

According to the invention, this object is achieved by the fact that deposition of the polysiloxane-based material is performed by plasma enhanced chemical vapor deposition in which a precursor chosen from cyclic organosiloxanes and cyclic organosilazanes is injected, the ratio between the power density dissipated in the plasma and the flow rate of precursor injected into the plasma being less than or equal to 100 W.cm⁻²/mol.min⁻¹.

### BRIEF DESCRIPTION OF THE DRAWINGS

Other advantages and features will become more clearly apparent from the following description of particular embodiments of the invention given for non-restrictive example purposes only and represented in the accompanying drawings, in which:

FIG. 1 illustrates, in cross-section, the different forces exerted on a drop of liquid arranged on a surface.

FIG. 2 illustrates, in cross-section, the advancing and receding angles for a drop of liquid arranged on an inclined surface.

FIGS. 3 and 4 respectively illustrate, in cross-section, measurement of the advancing and receding angles for a drop of liquid arranged on a non-inclined surface.

FIG. 5 represents the infrared spectrum of a polysiloxane material according to the invention deposited by plasma enhanced chemical vapor deposition (PECVD).

FIG. 6 graphically represents the variation of the wetting hysteresis versus the ratio r corresponding to the ratio between the number of linear —Si—O— bonds and the number cyclic —Si—O— bonds in a polysiloxane-based material.

FIG. 7 graphically represents the wetting hysteresis of a polysiloxane-based material having a ratio r equal to 0.3 and deposited by PECVD.

FIG. 8 graphically represents the variation of the ratio r versus the ratio RCP defined as the ratio between the power density dissipated in the plasma and the flow rate of the precursor injected in the plasma.

FIG. 9 graphically represents the variation of the roughness of a surface on which a material according to the invention is deposited, versus the coefficient RCP.

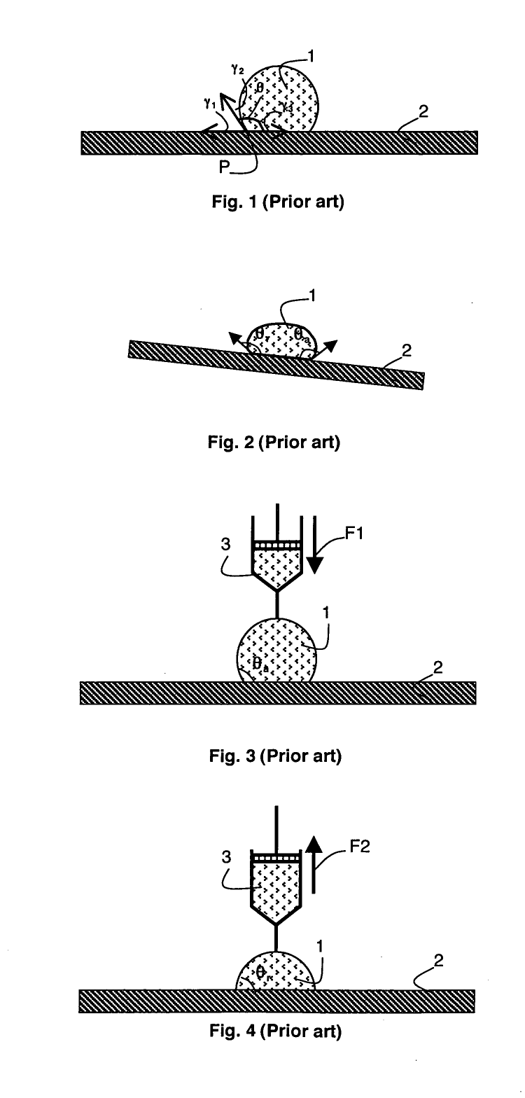

### DESCRIPTION OF PARTICULAR EMBODIMENTS

According to the invention, a polysiloxane-based material presents a predetermined structure or conformation such that, in the polysiloxane, the ratio between the number of linear —Si—O— bonds and the number of cyclic —Si—O— bonds is less than or equal to 0.4, and preferably less than or equal to 0.3.

What is meant by polysiloxane is a polymer having a macromolecular skeleton based on the —Si—O— chaining and wherein the ratio between the number of linear —Si—O— bonds and the number of cyclic —Si—O— bonds is noted r.

The polysiloxane-based material with such a conformation is preferably obtained by plasma enhanced chemical vapor deposition, PECVD in short. In addition, to form the polysiloxane-based material, a precursor chosen from cyclic organosiloxanes such as octamethylcyclotetrasiloxane, also noted OMCTS, and derivatives thereof and from cyclic organosilazanes such as octamethylcyclosilazane and derivatives thereof, is injected into the plasma. Said precursor can be diluted in helium before being injected into the plasma, and it is advantageously preferred as it presents the advantage of being cyclic.

The semi-structural formula of OMCTS is as follows:

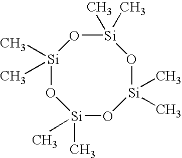

Advantageously the PECVD conditions are the following: pressure in the deposition chamber comprised between 0.1 and 1 mbar, RF power applied to the electrode generating the plasma comprised between 10 and 400 W, precursor flow rate comprised between 10⁻⁴ and 10⁻² mol/min and helium flow rate from 0 to 500 sccm.

Thus for example, a polysiloxane deposition was made by injecting a OMCTS/Helium mixture previously made in a bottle heated to 60° C. to a vacuum deposition chamber by means of a bubbling system with a flow rate of about 0.2 litres per minute. The OMCTS/He mixture was then diluted in helium at a flow rate of 0.632 cm³/min and then inlet to the chamber. The flow rate of OMCTS injected into the plasma is then 2.5*10⁻⁴ mol/min. The power applied on the electrode generating the plasma was set to 0.02 W/cm², the distance between electrodes was set to 30 mm and the pressure within the chamber was maintained at 0.2 mbar during deposition of the polysiloxane-based material. These conditions enable a retention time Rt equal to 8 ms to be calculated. Rt corresponds to the time the precursor is present in the deposition chamber. The retention time is however very short in this example, which enables the cyclic structure of the precursor to be partially preserved. Indeed, the longer the retention time, the more the precursor bonds can be broken. Therefore, in the case of a cyclic precursor, the longer the retention time, the more the cycles tend to open and the more the final material presents linear —Si—O— bonds.

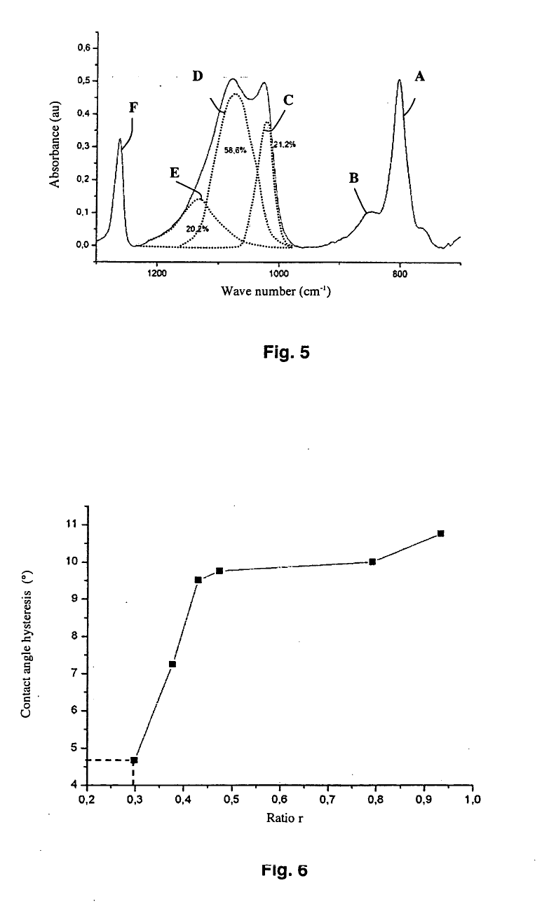

Analysis of the deposition was then performed by infrared spectroscopy (FTIR), as represented in FIG. 5. Analysis of the infrared spectrum in fact enables qualitative and semi-quantitative information to be obtained on the nature of the chemical bonds present in the polysiloxane-based material. Each absorption peak of the IR spectrum in fact occurs at a wave number corresponding to a vibration mode proper to a specific chemical bond. Table 1 below indicates the corresponding vibration mode for each absorption peak of FIG. 5.

TABLE 1

| Absorption peak | Wave number | Vibration mode - |
|---|---|---|
| reference | (cm⁻¹) | corresponding bond |
| A | 800 | ∂ᵣ CH₃ in Si(CH₃)₂ |
| B | 840 | ∂ᵣ CH₃ in Si(CH₃)₃ |
| C | 1020 | υₐ linear SiOSi |
| D | 1080 | υ cyclic SiOSi |
| E | 1130 | υ SiOC in SiOCH₃ |
| F | 1250-1270 | ∂ₛ CH₃ in Si(CH₃)_{3/2/1} |

In FIG. 5, it can therefore be observed that the infrared spectrum of the deposition made comprises three peaks C, D and E corresponding to the —Si—O— chemical bond. The relative proportion of each group was evaluated semi-quantitatively by measuring the area under each specific infrared absorption peak. Referring to table 1, it can thus be observed that 58.6% of the —Si—O— chemical bonds are present in cyclic —Si—O—Si— form (peak D) corresponding to the cyclic structure of the precursor used to perform the deposition, 21.2% of the —Si—O— chemical bonds are present in linear —Si—O—Si form corresponding to opening of the precursor cycles (peak C) and 20.2% of the —Si—O—Si bonds are present in the form of —Si—O—C— of the Si—O—CH₃ group (peak E). The value of the areas under the absorption peaks thus enables the ratio r corresponding to the ratio between the number of linear —Si—O— bonds and the number of cyclic —Si—O— bonds to be determined. Here the ratio r is equal to 0.36.

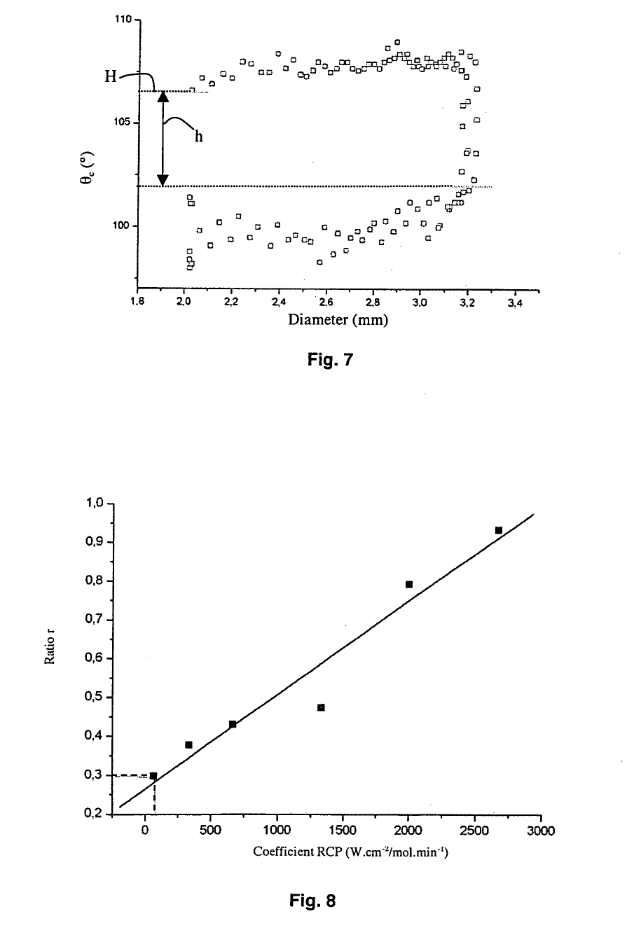

As illustrated in FIG. 6, such a polysiloxane conformation enables a material presenting a very low wetting hysteresis to be obtained. Indeed, a polysiloxane-based material presenting a ratio r less than or equal to 0.4 and preferably less than or equal to 0.3 enables a wetting hysteresis, or contact angle hysteresis, of less than 10° or even less than 5°, to be obtained. It can thus be observed in FIG. 6 that a polysiloxane-based material with a ratio r of 0.3 presents a wetting hysteresis of about 4.5°. This is moreover confirmed by measuring the contact angle, as illustrated in FIG. 7. FIG. 7 in fact corresponds to a graph measuring the contact angle (θ_{c} in °) versus the diameter (in mm) of a drop of water deposited on the surface of a polysiloxane coating having a ratio r of 0.3. The coating was obtained by PECVD by means of the OMCTS precursor, and it has a thickness of 1 μm. As illustrated in FIGS. 3 and 4, the contact angle is measured by means of a camera, using a deposition system (syringe 3) of a drop of water 1 on the surface 2 of the coating. For example, the system used is an automated system marketed by the Kruss Company under the name of Drop Shape Analysis system DSA 10mk2, enabling not only the contact angle but also the wetting hysteresis to be measured by increasing and decreasing the volume of the drop. The wetting hysteresis phenomenon can then be visualized for the polysiloxane coating via a series of measurements and the contact angle characterizing the hydrophobicity and the wetting hysteresis can be determined. Thus, as illustrated in FIG. 7, the hydrophobicity H is about 107° and the wetting hysteresis h is about 4.5°.

A polysiloxane-based material with a ratio r less than or equal to 0.4, and preferably less than or equal to 0.3, can be obtained by controlling the PECVD deposition conditions, and more particularly by controlling the conditions relating to the plasma. The parameters such as plasma power density and precursor flow rate in fact enable this ratio r to be varied significantly. FIG. 8 thus represents the variation of the ratio r versus a coefficient RCP (Remote Control Parameter) corresponding to the ratio between the power density dissipated in the plasma and the flow rate of precursor injected into the plasma. It can thus be observed that the ratio r varies linearly with the coefficient RCP and that a coefficient RCP less than or equal to 100 W.cm⁻²/mol.min⁻¹ enables a ratio r less than or equal to 0.4 to be obtained. More particularly, a coefficient RCP less than or equal to 67 W.cm⁻²/mol.min⁻¹ enables a ratio r less than or equal to 0.3 W.cm⁻²/mol.min⁻¹ to be obtained.

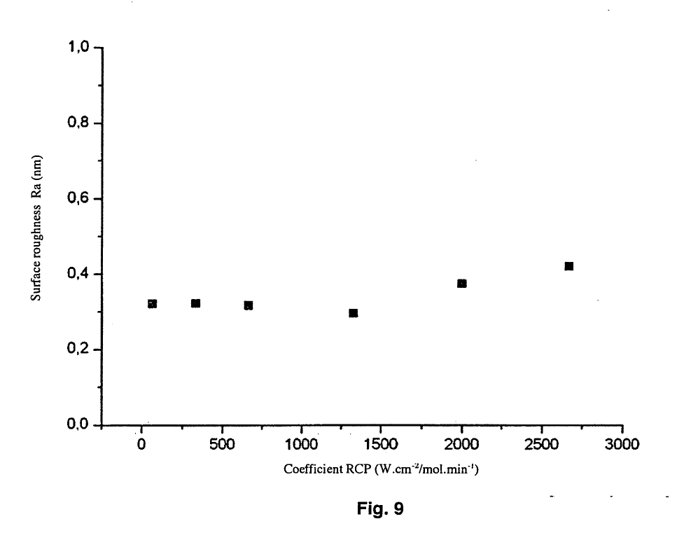

It can also be observed, in FIG. 9 representing the variation of the surface roughness of a polysiloxane-based material coating versus the coefficient RCP, that the surface roughness (Ra) remains invariant whatever the coefficient RCP, i.e. whatever the plasma conditions used.

Thus, by controlling the coefficient RCP of a plasma used in a PECVD method in predetermined manner, it is possible to obtain a polysiloxane-based material having a low wetting hysteresis without having to perform an additional step after deposition of the material, such as a surface treatment step. With such a material and/or such a deposition method, it is indeed not necessary to modify the surface roughness of the material to obtain a low wetting hysteresis. This therefore enables a surface having a very high dewetting capacity to be obtained without having to modify the topology of said surface.

A material according to the invention can be used in a large number of applications. For example, it can be used as surface coating of a mould deigned for producing polymer microparts. A mould coated with a low wetting hysteresis film, for example with a wetting hysteresis less than 5°, does in fact enable complex and possibly even nanometric patterns to be stripped from the mould with a very low applied force. In addition, if the moulding and stripping forces are isostatic, a mould coated with a low wetting hysteresis film presents an improved lifetime.

Such a low wetting hysteresis material according to the invention can also be used as hydrophobic surface coating in a microcomponent designed to move drops, by electrowetting or as extremely slippery surface coating on a transparent polymer support used in the optics field.

1-8. (canceled)

9. A low wetting hysteresis polysiloxane-based material having a ratio between a number of linear —Si—O— bonds and a number of cyclic —Si—O— bonds less than or equal to 0.4.

10. The material according to claim 9, wherein the ratio between the number of linear —Si—O— bonds and the number of cyclic —Si—O— bonds is less than or equal to 0.3.

11. The material according to claim 9 having a wetting hysteresis less than 10°.

12. The material according to claim 11, wherein the wetting hysteresis is less than 5°.

13. A method for depositing the low wetting hysteresis polysiloxane-based material according to claim 9 on a surface by chemical vapor deposition enhanced by a plasma in which a precursor selected from the group consisting of cyclic organosiloxanes and cyclic organosilazanes is injected, a ratio between a power density dissipated in the plasma and a precursor flow rate injected into the plasma being less than or equal to 100 W.cm⁻²/mol.min⁻¹.

14. The method for depositing according to claim 13, wherein the precursor is selected from the group consisting of octomethylcyclotetrasiloxane and derivatives thereof.

15. The method for depositing according to claim 13, wherein the precursor is selected from the group consisting of octamethylcyclotetrasilazane and derivatives thereof.

16. The method for depositing according to claim 13, wherein the precursor is diluted in helium before being injected into the plasma.
